(19) United States
(12) Patent Application Publication
(10) Pub. No.: US 2012/0069445 A1
(43) Pub. Date: Mar. 22, 2012

(54) HEAD-MOUNTED DISPLAY SHIELD AND HEAD MOUNTED DISPLAY

(75) Inventor: Hiroyoshi KOBAYASHI, Tokyo (JP)

(73) Assignee: OLYMPUS CORPORATION, Tokyo (JP)

(21) Appl. No.: 13/232,275

(22) Filed: Sep. 14, 2011

(30) Foreign Application Priority Data
Sep. 17, 2010 (JP) 2010-209275

(51) Int. Cl. G02B 27/01; B32B 3/06

(52) U.S. Cl. 359/630; 428/99

(57) ABSTRACT

Increased impact resistance can be achieved without impairing the comfort when worn. Provided is a head-mounted-display shield attached to a head mounted display including a pair of optical units each having a display device, and a frame that supports the optical units and that is to be mounted to a wearer's head. The head-mounted-display shield includes shield bodies that are composed of an elastically deformable material, that are each separated from an outline of the neighboring optical unit by a space and disposed at a position where the frame does not extend between the shield body and the outline, and that are each disposed at least at a position where the shield body forms a plane across which the corresponding optical unit does not extend; and an attachment section attached to the frame.

### BACKGROUND OF THE INVENTION

1. Field of the Invention

The present invention relates to head-mounted-display shields and head mounted displays.

This application is based on Japanese Patent Application No. 2010-209275, the contents of which are incorporated herein by reference.

2. Description of Related Art

In the related art, there are known head mounted displays (HMDs) having a configuration for preventing damage caused by an impact (for example, see Japanese Unexamined Patent Application, Publication No. 11-174988, and Japanese Unexamined Patent Application Publication No. 9-130702). In Japanese Unexamined Patent Application, Publication No. 11-174988, a shock absorbing member that absorbs an impact transmitted to a securing member, which secures a display device in place, is provided to prevent deviation of the optical axis caused by deformation of the securing member. In Japanese Unexamined Patent Application Publication No. 9-130702, an impact absorbing member is provided at a position that tends to receive an impact when the HMD is dropped.

In the case of Japanese Unexamined Patent Application, Publication No. 11-174988, a cover that accommodates an optical system including a display device is not protected. If the cover breaks, there is a conceivable risk that the optical system disposed therein may break. If this configuration were to be designed so that the optical system can sufficiently endure a large impact, the shock absorbing member would need to be increased in size. In that case, the size and the weight of the entire optical unit would increase, resulting in the wearer feeling reduced comfort when worn. In the case of Japanese Unexamined Patent Application Publication No. 9-130702, providing the impact absorbing member at a position that tends to receive an impact to increase impact resistance leads to increased discomfort when worn due to the same reason as in Japanese Unexamined Patent Application, Publication No. 11-174988.

The present invention provides a head-mounted-display shield and a head mounted display that allow for increased impact resistance without impairing the comfort when worn.

### BRIEF SUMMARY OF THE INVENTION

A first aspect of the present invention provides a head-mounted-display shield attached to a head mounted display including a pair of optical units each having a display device, and a frame that supports the optical units and that is to be mounted to a wearer's head. The head-mounted-display shield includes shield bodies that are composed of an elastically deformable material, that are each separated from an outline of the neighboring optical unit by a space and disposed at a position where the frame does not extend between the shield body and the outline, and that are each disposed at least at a position where the shield body forms a plane across which the corresponding optical unit does not extend; and an attachment section that attaches the shield bodies to the frame.

According to the present invention, since the optical units are disposed inward of the planes formed by the shield bodies and the frame, an object approaching the HMD from any direction first comes into contact with the shield bodies or the frame, whereby the optical units can be protected.

In this case, the impact received by the shield bodies is absorbed due to elastic deformation of the shield bodies within the space formed between the shield bodies and the optical units, and the impact that is not sufficiently absorbed by the shield bodies is transmitted to the frame via the attachment section. Consequently, even with the shield bodies having a simple configuration, an impact transmitted to the optical units is sufficiently attenuated so as to allow for increased impact resistance, and the shield bodies can be simplified and reduced in weight so that the comfort when worn can be prevented from being impaired.

In the above-described aspect, the attachment section may be detachable from the frame.

Accordingly, the shield bodies of the head-mounted-display shield alone can be readily replaced if they are damaged or dirty.

In the above-described aspect, the attachment section may have an elastic member at a position between the attachment section and the frame.

Accordingly, when the shield bodies come into contact with an object, the impact transmitted to the frame from the shield bodies is dampened by the elastic member, whereby the optical units can be protected more effectively.

In the above-described aspect, the attachment section may be disposed inward of an external tangent constituted of a group of outermost line segments among line segments that connect two points on outlines of the shield bodies.

Accordingly, since an object comes into contact with the shield bodies at an area other than the attachment section, the impact received by the attachment section is attenuated, thereby preventing the attachment section from becoming detached from the frame at the time of contact.

In the above-described aspect, each shield body may have an elastic modulus that decreases with increasing distance from the attachment section.

Accordingly, when the shield bodies come into contact with an object, the areas thereof that are farther away from the attachment section are elastically deformed by a greater amount so as to absorb more impact, thereby attenuating the impact received by the attachment section.

In the first aspect of the present invention, the shield bodies may be composed of an optically transparent material.

Accordingly, a view of the outside can be ensured through the shield bodies so as to reduce a sense of claustrophobia felt by the wearer.

A second aspect of the present invention provides a head mounted display that includes a pair of optical units each having a display device; a frame that supports the optical units and that is to be mounted to a wearer's head; and the aforementioned head-mounted-display shield that is attached to the frame.

According to the present invention, increased impact resistance can be advantageously achieved without impairing the comfort when worn.

### BRIEF DESCRIPTION OF THE SEVERAL VIEWS OF THE DRAWINGS

FIG. 1 is a plan view illustrating the overall configuration of an HMD according to an embodiment of the present invention.

FIG. 2 is a front view of the HMD in FIG. 1.

FIG. 3 is a right side view of the HMD in FIG. 1.

FIG. 4A is a plan view illustrating the overall configuration of an HMD shield according to an embodiment of the present invention.

FIG. 4B is a front view illustrating the overall configuration of the HMD shield according to the embodiment of the present invention.

FIG. 4C is a right side view illustrating the overall configuration of the HMD shield according to the embodiment of the present invention.

FIG. 4D is a cross-sectional view illustrating the overall configuration of the HMD shield according to the embodiment of the present invention, taken along line IV-IV in FIG. 4B.

FIG. 5 is a plan view illustrating a state where the HMD shield shown in FIGS. 4A to 4D is attached to the HMD shown in FIG. 1.

FIG. 6 is a front view of the HMD shown in FIG. 5.

FIG. 7 is a right side view of the HMD shown in FIG. 5.

FIG. 8A is a plan view illustrating a first modification of the HMD shield shown in FIGS. 4A to 4D.

FIG. 8B is a front view illustrating the first modification of the HMD shield shown in FIGS. 4A to 4D.

FIG. 8C is a right side view illustrating the first modification of the HMD shield shown in FIGS. 4A to 4D.

FIG. 8D is a cross-sectional view illustrating the first modification of the HMD shield shown in FIGS. 4A to 4D, taken along line IIX-IIX in FIG. 8B.

FIG. 9A is a plan view illustrating a second modification of the HMD shield shown in FIGS. 4A to 4D.

FIG. 9B is a front view illustrating the second modification of the HMD shield shown in FIGS. 4A to 4D.

FIG. 9C is a right side view illustrating the second modification of the HMD shield shown in FIGS. 4A to 4D.

FIG. 9D is a cross-sectional view illustrating the second modification of the HMD shield shown in FIGS. 4A to 4D, taken along line IX-IX in FIG. 9B.

FIG. 10A is a plan view illustrating a third modification of the HMD shield shown in FIGS. 4A to 4D.

FIG. 10B is a front view illustrating the third modification of the HMD shield shown in FIGS. 4A to 4D.

FIG. 10C is a right side view illustrating the third modification of the HMD shield shown in FIGS. 4A to 4D.

FIG. 10D is a cross-sectional view illustrating the third modification of the HMD shield shown in FIGS. 4A to 4D, taken along line X-X in FIG. 10B.

### DETAILED DESCRIPTION OF THE INVENTION

An HMD 10 and an HMD shield 1 according to an embodiment of the present invention will be described below with reference to the drawings.

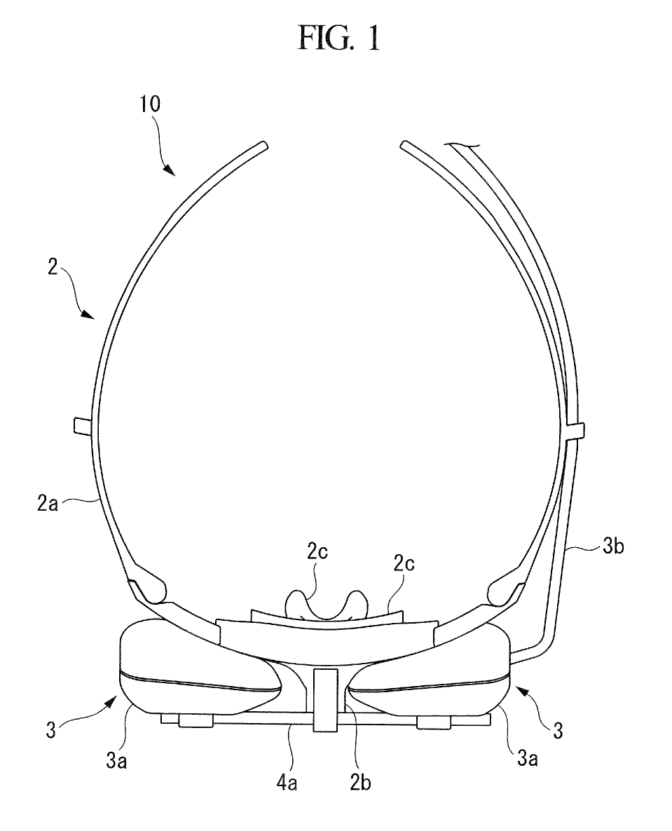

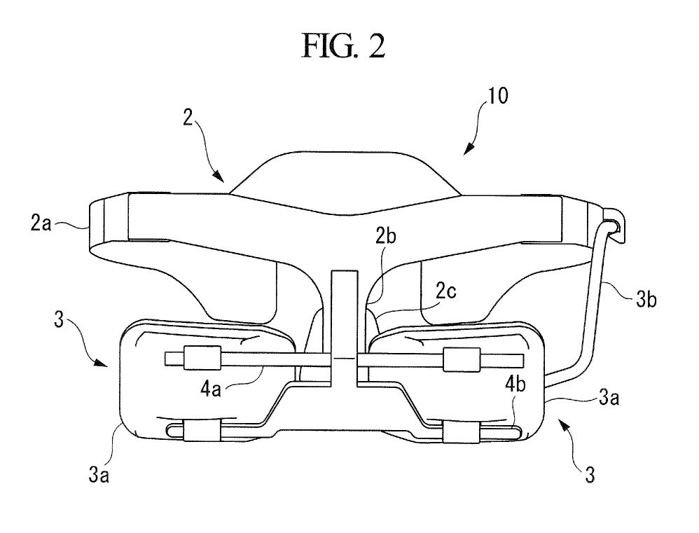

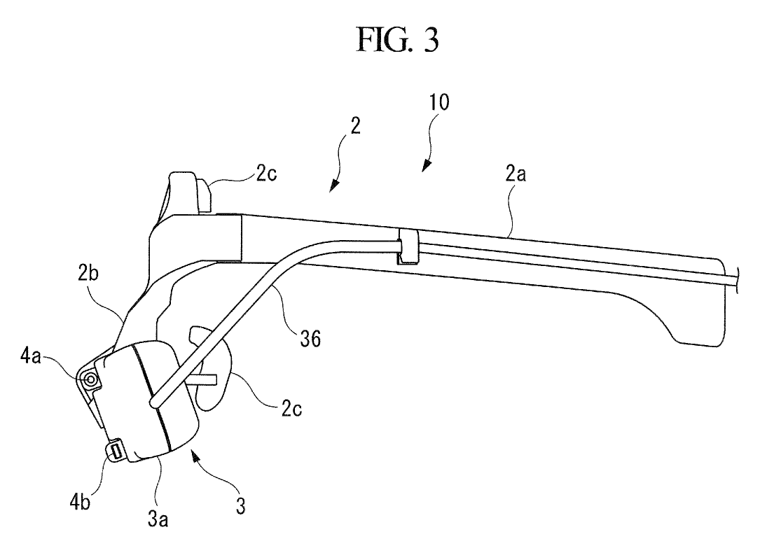

FIGS. 1, 2, and 3 respectively illustrate a plan view, a front view, and a right side view of the HMD 10 according to this embodiment. The HMD 10 according to this embodiment includes a frame 2 to be mounted to a wearer's head, and a pair of left and right optical units 3 to be disposed in front of the wearer's eyes and having built-in display devices.

The frame 2 has an annular frame body 2a that surrounds the frontal and temporal regions of the wearer's head, and a shaft 2b that is connected to the frame body 2a and extends substantially along the center line of the wearer's face when the frame body 2a is mounted to the head. A pad 2c formed of an elastic material is provided at a position to be in abutment with the nose and the frontal region of the head so that the frame body 2a can be stably mounted in conformity to the shape of the wearer's head and face.

The optical units 3 each include an optical system (not shown) including a display device, and a housing 3a that accommodates the optical system. An image acquired by an endoscope or the like (not shown) is transmitted to a controller (not shown) via wired or wireless image transmission means. Then, the controller supplies power and the image to the optical units 3 via a cable 3b. The optical units 3 display the supplied image on the display devices and optically guide the image on the display devices to the wearer's eyes via the optical systems.

The optical units 3 are supported by two guide rails 4a and 4b that are substantially parallel to each other. One guide rail 4a is attached to the shaft 2b in a rotatable manner in the circumferential direction. Thus, the wearer can vertically rotate the optical units 3 about the guide rail 4a acting as a central axis so as to adjust the angle of the image relative to the viewing direction while maintaining a relative angle between the left and right optical units 3. The left and right optical units 3 are provided in an independently movable manner along the two guide rails 4a and 4b so that the distance between the optical units 3 in the width direction can be adjusted in correspondence with the interpupillary distance of the wearer.

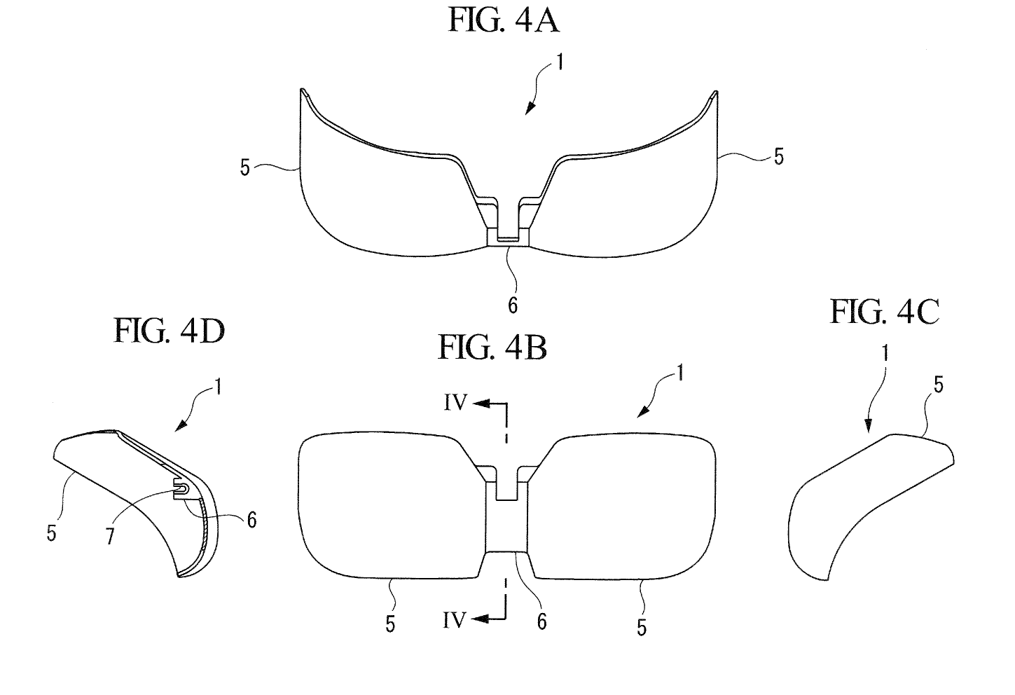

Referring to FIGS. 4A to 4D, the HMD shield 1 according to this embodiment has shield bodies 5 that cover the optical units 3, and an attachment section 6 that detachably attaches the shield bodies 5 to the guide rail 4a at a position between the left and right optical units 3.

The shield bodies 5 are composed of a material that is elastically deformable by an external force and that is optically transparent, such as polycarbonate resin. Thus, when the HMD shield 1 is attached to the HMD 10, the wearer's field of view is prevented from being blocked by the HMD shield 1, thereby reducing a sense of claustrophobia felt by the wearer.

In a state where the attachment section 6 is attached to the guide rail 4a, the shield bodies 5 each have a shape that forms a sufficiently large gap relative to the outer surface (outline) of the neighboring housing 3a. Each shield body 5 is disposed at least at a position where the shield body 5 and the outer surface of the neighboring housing 3a do not have the frame 2 interposed therebetween, as well as at a position where the shield body 5 forms a plane at the outer side of the housing 3a.

Accordingly, since the optical units 3 are disposed inward of the planes formed by the shield bodies 5 and the frame 2, an object approaching the HMD 10 from any direction first comes into contact with the shield bodies 5 or the frame 2, whereby the optical units 3 can be protected.

In this case, the impact received by the shield bodies 5 is absorbed due to elastic deformation of the shield bodies 5 within the space formed between the shield bodies 5 and the optical units 3, and the impact that is not sufficiently absorbed by the shield bodies 5 is transmitted to the frame 2 via the attachment section 6. Consequently, even with the shield bodies 5 having a simple configuration, an impact transmitted to the optical units 3 is sufficiently attenuated so as to allow for increased impact resistance, and the shield bodies 5 can be simplified and reduced in weight so that the comfort when worn can be prevented from being impaired.

The shield bodies 5 have a shape such that there are no outlines within the wearer's field of view when the optical units 3 are disposed in front of the wearer's eyes. Specifically, the shield bodies 5 have a shape that continuously covers the optical units 3 in the vertical direction and the horizontal direction. The edges of the shield bodies 5 at the upper side of the optical units 3 are disposed sufficiently near the frame 2, whereas the edges of the shield bodies 5 at the lower side of the optical units 3 are disposed at sufficiently low positions so as to be hidden by the optical units 3.

Even if the shield bodies 5 are composed of an optically transparent material, the wearer could still clearly see the outlines of the shield bodies 5. Therefore, the outlines of the shield bodies 5 are disposed outside the wearer's field of view so that the wearer can use the HMD shield 1 without being distracted by the shield bodies 5.

In addition, the shield bodies 5 are preferably formed such that the shield bodies 5 increase in thickness toward the attachment section 6 and decrease in thickness away from the attachment section 6. Accordingly, when the shield bodies 5 receive an impact, the areas thereof that are farther away from the attachment section 6 are elastically deformed by a greater amount so as to absorb more impact, thereby attenuating the impact transmitted to the attachment section 6. Consequently, when the HMD shield 1 comes into contact with an object, the possibility of the HMD shield 1 becoming detached from the frame 2 can be reduced.

The attachment section 6 has a recess 6a that is fittable to the guide rail 4a. When the HMD shield 1 is damaged or dirty, the wearer can easily detach the HMD shield 1 alone from the HMD 10 and attach a new HMD shield 1 thereto. The inner surface of the recess 6a is covered with an elastic member 7 such that the recess 6a is fitted to the guide rail 4a with the elastic member 7 interposed between the recess 6a and the outer surface of the guide rail 4a. Consequently, when the shield bodies 5 receive an impact, the impact is absorbed by the elastic member 7 at the attachment section 6 serving as a joint with the frame 2, whereby the impact transmitted from the HMD shield 1 to the frame 2 and the optical units 3 can be further attenuated.

Among line segments that connect two points on the outlines of the shield bodies 5, the attachment section 6 is provided inward of an outermost line segment relative to the optical units 3. Thus, when the HMD shield 1 comes into contact with a substantially flat object, such as the floor or a wall, the object comes into contact with the shield bodies 5 instead of the attachment section 6, whereby the attachment section 6 can be prevented from being detached from the guide rail 4a as a result of the attachment section 6 directly receiving an impact, and the impact received by the attachment section 6 can be attenuated.

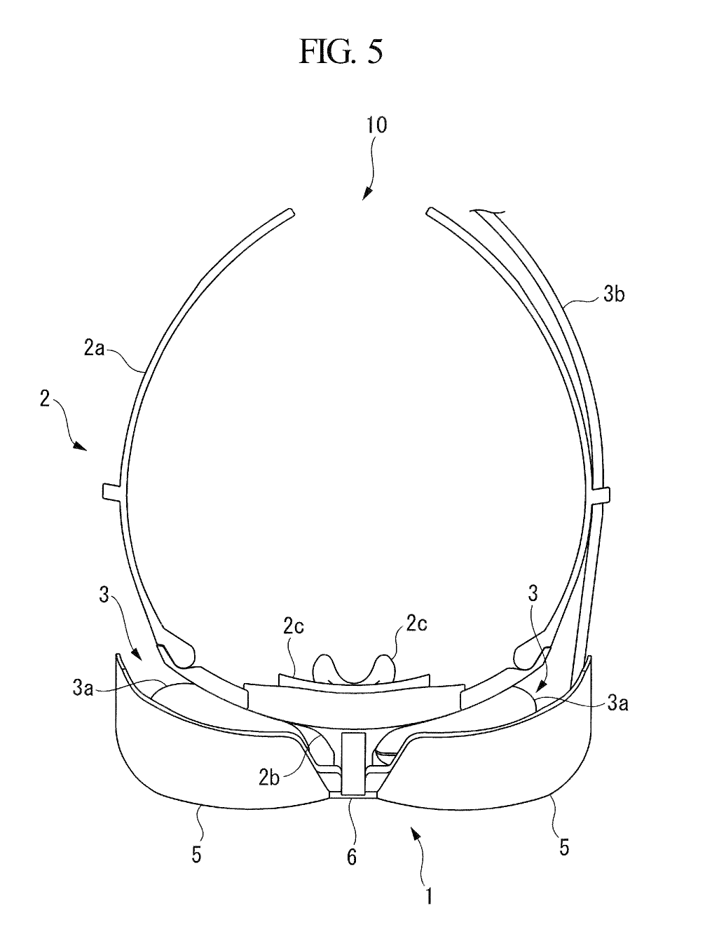

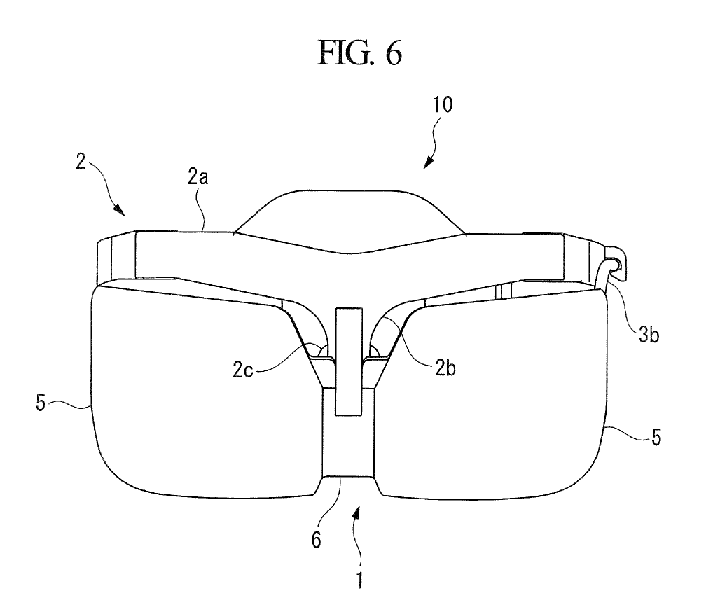

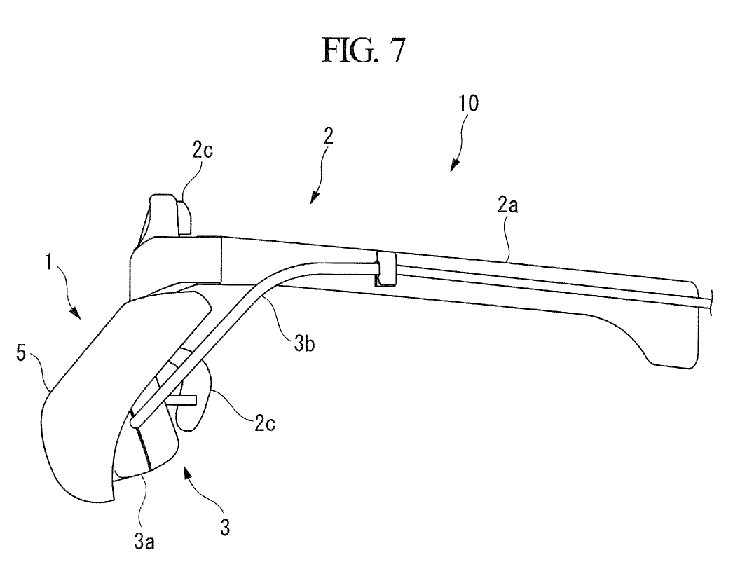

Next, the operation of the HMD shield 1 having the above-described configuration and the HMD 10 equipped with the HMD shield 1 will be described. FIGS. 5, 6, and 7 respectively illustrate a plan view, a front view, and a right side view of the HMD 10 having the HMD shield 1 attached thereto.

The wearer wears the frame 2 around his/her head so that the optical units 3 are disposed in front of his/her eyes, and an image is input to the optical units 3 from an external device, whereby the wearer can observe the image displayed on the display devices.

If the operator accidentally drops the HMD 10 or hits the HMD 10 against an object, the HMD shield 1 or the frame 2 first comes into contact with the floor or the object. In this case, the shield bodies 5 of the HMD shield 1 receive the impact resulting from the contact and are thus elastically deformed within the space formed between the shield bodies 5 and the optical units 3, so that the impact is absorbed without being transmitted to the neighboring optical units 3. The impact that is not sufficiently absorbed by the shield bodies 5 is attenuated by the elastic member 7 via the attachment section 6 before being transmitted to the frame 2.

According to this embodiment, even though the HMD shield 1 has a simple configuration, the impact can be sufficiently dampened by the space provided between the shield bodies 5 and the optical units 3. Consequently, the impact resistance can be advantageously increased by sufficiently protecting the optical units 3 from a relatively large impact, while maintaining good comfort when worn without increasing the discomfort when worn by the wearer.

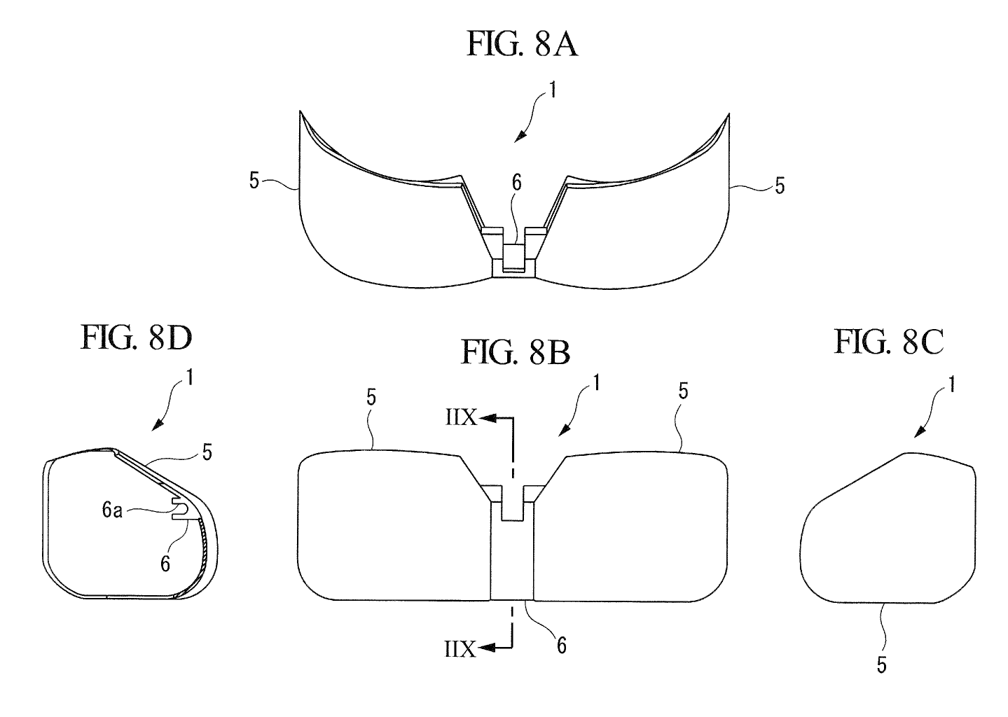

The shape of the HMD shield 1 shown in FIGS. 4A to 4D is merely an example and is not limited thereto. Examples of alternative shapes of the HMD shield 1 according to this embodiment are shown in FIGS. 8A to 10D.

The HMD shield 1 shown in FIGS. 8A to 8D has a shape that entirely covers the side surfaces of the optical units 3. Thus, when an object approaches the HMD 10 from the left or right direction, the optical units 3 can be reliably protected.

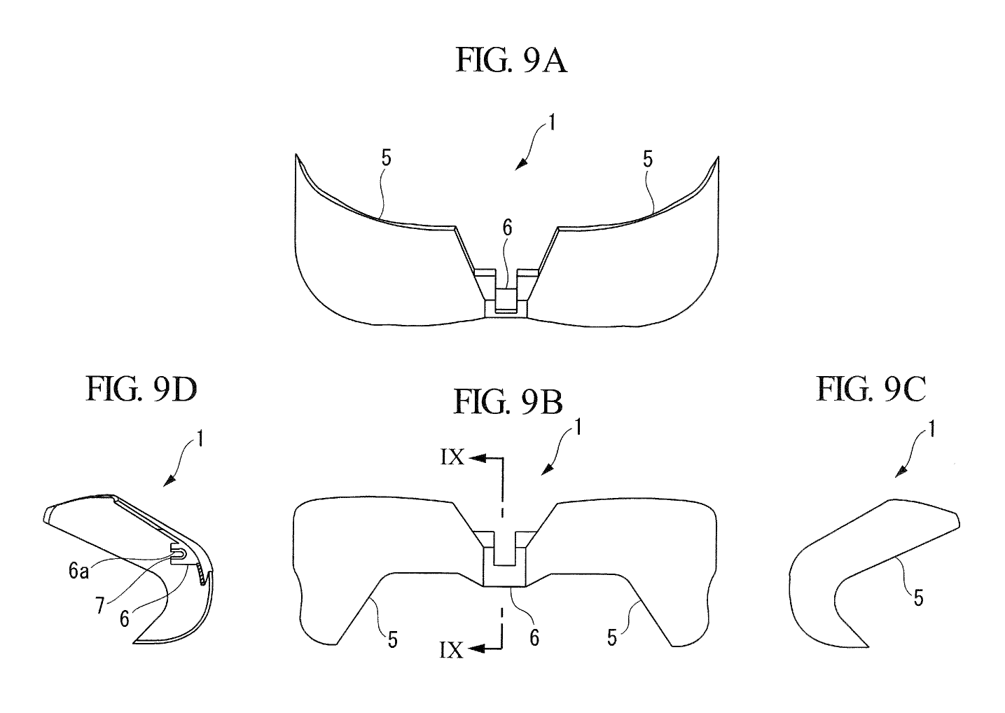

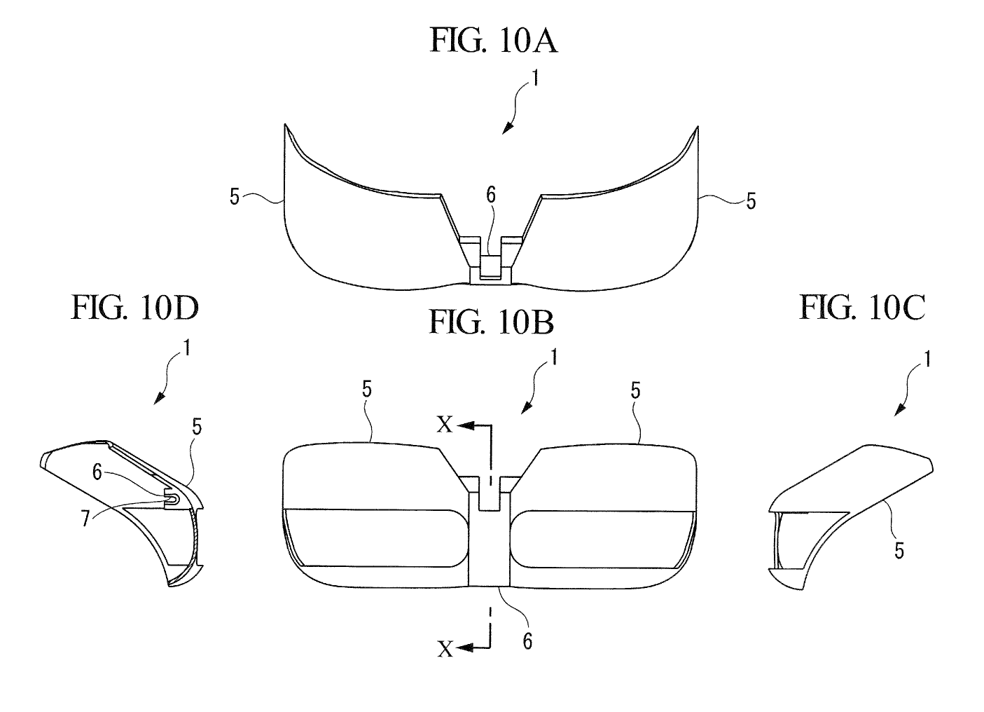

FIGS. 9A to 9D and FIGS. 10A to 10D each illustrate a shape in which the shield bodies 5 are partially cut away at positions where the wearer's field of view would be blocked by the optical units 3. Consequently, the shield bodies 5 can be further reduced in weight.

In order to attenuate an impact transmitted to the attachment section 6 in this embodiment, the shield bodies 5 are formed to decrease in thickness away from the attachment section 6 so as to increase the ability to absorb an impact. Alternatively, the areas of the shield bodies 5 that are close to the attachment section 6 may be composed of a material with a relatively high elastic modulus, whereas the areas of the shield bodies 5 that are far from the attachment section 6 may be composed of a material with a relatively low elastic modulus. In this manner, the ability of the shield bodies 5 to absorb an impact can be increased at positions far from the attachment section 6 so that the impact acting on the attachment section 6 can be attenuated.

1. A head-mounted-display shield attached to a head mounted display including a pair of optical units each having a display device, and a frame that supports the optical units and that is to be mounted to a wearer's head, the head-mounted-display shield comprising:
shield bodies composed of an elastically deformable material, each shield body being separated from an outline of the neighboring optical unit by a space and disposed at a position where the frame does not extend between the shield body and the outline, each shield body being disposed at least at a position where the shield body forms a plane across which the corresponding optical unit does not extend; and
an attachment section that attaches the shield bodies to the frame.

2. The head-mounted-display shield according to claim 1, wherein the attachment section is detachable from the frame.

3. The head-mounted-display shield according to claim 1, wherein the attachment section has an elastic member at a position between the attachment section and the frame.

4. The head-mounted-display shield according to claim 2, wherein the attachment section is disposed inward of an external tangent constituted of a group of outermost line segments among line segments that connect two points on outlines of the shield bodies.

5. The head-mounted-display shield according to claim 2, wherein each shield body has an elastic modulus that decreases with increasing distance from the attachment section.

6. The head-mounted-display shield according to claim 1, wherein the shield bodies are composed of an optically transparent material.

7. A head mounted display comprising:
a pair of optical units each having a display device;
a frame that supports the optical units and that is to be mounted to a wearer's head; and
the head-mounted-display shield according to claim 1 that is attached to the frame.

8. A head mounted display comprising:
a pair of optical units each having a display device;
a frame that supports the optical units and that to be mounted to a wearer's head; and
the head-mounted-display shield according to claim 2 that is attached to the frame.

9. A head mounted display comprising:
a pair of optical units each having a display device;
a frame that supports the optical units and that is to be mounted to a wearer's head; and
the head-mounted-display shield according to claim 3 that is attached to the frame.

10. A head mounted display comprising:
a pair of optical units each having a display device;
a frame that supports the optical units and that is to be mounted to a wearer's head; and
the head-mounted-display shield according to claim 4 that is attached to the frame.

11. A head mounted display comprising:
a pair of optical units each having a display device;
a frame that supports the optical units and that is to be mounted to a wearer's head; and
the head-mounted-display shield according to claim 5 that is attached to the frame.

12. A head mounted display comprising:
a pair of optical units each having a display device;
a frame that supports the optical units and that is to be mounted to a wearer's head; and
the head-mounted-display shield according to claim 6 that is attached to the frame.
